(19) United States
(12) Patent Application Publication
(10) Pub. No.: US 2019/0198219 A1
(43) Pub. Date: Jun. 27, 2019

(54) INDUCTOR

(71) Applicant: Murata Manufacturing Co., Ltd., Kyoto-fu (JP)

(72) Inventors: Seigou SHIRAI, Nagaokakyo-shi (JP); Kachiyasu SATOU, Nagaokakyo-shi (JP)

(73) Assignee: Murata Manufacturing Co., Ltd., Kyoto-fu (JP)

(21) Appl. No.: 16/181,002

(22) Filed: Nov. 5, 2018

(30) Foreign Application Priority Data
Dec. 26, 2017 (JP) 2017-249822

(51) Int. Cl. H01F 27/02; H01F 27/28; H01F 27/24; H01F 41/00; H01F 41/063

(52) U.S. Cl. CPC H01F 27/022; H01F 27/2823; H01F 41/063; H01F 41/005; H01F 27/24

(57) ABSTRACT

An inductor includes a core, a coil having a conductor wound around the core, and an sealing body accommodating the core and the coil. The core includes a lamination portion in which a magnetic body layer and an insulator layer are alternately laminated and is arranged such that a lamination direction of the lamination portion is orthogonal to a winding axis of the coil. The magnetic body of the core has higher magnetic permeability than the sealing body. The core has a region in which an area of a cross section orthogonal to a winding axis direction is smaller than an area of a cross section of a near-side portion in at least one direction of the winding axis of the coil.

### CROSS-REFERENCE TO RELATED APPLICATION

This application claims benefit of priority to Japanese Patent Application No. 2017-249822, filed Dec. 26, 2017, the entire content of which is incorporated herein by reference.

### BACKGROUND

### Technical Field

The present disclosure relates to an inductor.

### Background Art

As a power inductor, an inductor in which a winding is sealed by a sealing material obtained by kneading magnetic powder and resin has been widely used. An inductor disclosed in Japanese Unexamined Patent Application Publication No. 2016-119385 is manufactured by sandwiching a coil with a sealing material molded by pressure and further molding the coil and the sealing material by pressure.

However, the above-described sealing material has lower permeability and a lower inductance than ferrite or soft magnetic alloys. Therefore, in order to obtain a desired inductance, a large number of turns of the coil are required to be wound and there has been a problem that direct-current (DC) resistance of the inductor tends to increase. In addition, when the ferrite or the soft magnetic alloy is arranged in an inner space (cavity) of the winding for use in place of the sealing material, the soft magnetic alloy is easy to be magnetically saturated, so that a DC superimposed saturation current of the inductor tends to decrease. Further, magnetic fluxes concentrate on a portion of the ferrite or the soft magnetic alloy in the vicinity of the winding, and a Q factor therefore tends to decrease.

### SUMMARY

In view of the above problems, it is an object of the present disclosure to provide an inductor capable of achieving both of a high inductance and a high Q factor.

An inductor according to an aspect of the present disclosure includes a core, a coil having a conductor wound around the core, and an sealing body accommodating the core and the coil. The core includes a lamination portion in which a magnetic body and an insulator are alternately laminated and is arranged such that a lamination direction of the lamination portion is orthogonal to a winding axis direction of the coil. The magnetic body of the core has higher magnetic permeability than the sealing body. Also, the core has a region where an area of a cross section orthogonal to the winding axis direction of the coil is smaller than an area of a cross section of a near-side portion in at least one direction of the winding axis direction of the coil.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a transparent perspective view of an inductor in a first embodiment;

FIG. 2 is a perspective view of a core that is used for the inductor in the first embodiment;

FIG. 3 is an enlarged view of an upper surface of the core that is used for the inductor in the first embodiment;

FIG. 4 is a cross-sectional view illustrating magnetic flux density distribution of an inductor in a first comparative example;

FIG. 5 is a cross-sectional view illustrating magnetic flux density distribution of an inductor in a second comparative example;

FIG. 6 is a cross-sectional view illustrating magnetic flux density distribution of the inductor in the first embodiment;

FIG. 7 is a perspective view of another example of the core that is used for the inductor in the first embodiment;

FIG. 8 is a perspective view of another example of the core that is used for the inductor;

FIG. 9 is a cross-sectional view of still another example of the core that is used for the inductor;

FIG. 10 is a perspective view of still another example of the core that is used for the inductor;

FIG. 11 is a perspective view of still another example of the core that is used for the inductor;

FIG. 12 is a perspective view of still another example of the core that is used for the inductor;

FIG. 13 is a perspective view of still another example of the core that is used for the inductor;

FIG. 14 is a perspective view of still another example of the core that is used for the inductor;

FIG. 15 is a perspective view of still another example of the core that is used for the inductor;

FIG. 16 is a transparent perspective view of an inductor in a third embodiment;

FIG. 17 is a perspective view of an example of a core that is used for the inductor in the third embodiment;

FIG. 18 is a perspective view of another example of the core that is used for the inductor in the third embodiment; and

FIG. 19 is a cross-sectional view of an inductor in a fourth embodiment.

### DETAILED DESCRIPTION

An inductor includes a core, a coil having a conductor wound around the core, and an sealing body accommodating the core and the coil. The core includes a lamination portion in which a magnetic body and an insulator are alternately laminated and is arranged such that a lamination direction of the lamination portion is orthogonal to a winding axis direction of the coil. The magnetic body of the core has higher magnetic permeability than the sealing body. Also, the core has a region in which an area of a cross section orthogonal to the winding axis direction of the coil is smaller than an area of a cross section of a near-side portion in at least one direction of the winding axis direction of the coil. When the core includes the magnetic body having the higher permeability than the sealing body, a high inductance can be obtained. Further, since the core has the region in which the area of the cross section orthogonal to the winding axis direction of the coil gradually decreases toward at least one direction of the winding axis direction of the coil, concentration of magnetic fluxes on an outer peripheral portion of the core, which is close to the coil, is moderated and eddy current loss is reduced, so that a high Q factor can be obtained.

The core may have a cross section having a region in which a length of the core in the winding axis direction of the coil in a portion closer to the coil is shorter than that in a portion farther from the coil in at least part of a cross section parallel to the winding axis direction of the coil. Since the length of the core in the winding axis direction of the coil in the outer peripheral portion of the core, which is close to the coil, is shortened, the concentration of the magnetic fluxes on the outer peripheral portion of the core is moderated.

The core may have a portion having a length shorter than a maximum value (a height of the core) of the length of the core in the winding axis direction of the coil at a position closer to the coil than a portion with the maximum value of the length of the core in a cross section parallel to the winding axis direction of the coil and orthogonal to a lamination surface of the lamination portion. Since the length of the core in the winding axis direction of the coil in the outer peripheral portion of the core, which is close to the coil, is shortened, the concentration of the magnetic fluxes on the outer peripheral portion of the core is moderated.

The core may have a cross section of a substantially convex polygonal shape having two parallel sides orthogonal to the winding axis direction of the coil and equal to or more than six vertices in at least part of a cross section parallel to the winding axis direction of the coil and parallel to or orthogonal to the lamination direction of the lamination portion. In addition, the core may have a cross section of a substantially convex octagonal shape having two parallel sides orthogonal to the winding axis direction of the coil in at least part of a cross section parallel or orthogonal to the winding axis direction of the coil and the lamination direction of the lamination portion. Having a specific cross-sectional shape of the core provides a higher inductance and improved core manufacturing efficiency.

A height of the core may be higher than a height of the coil in the winding axis direction of the coil, and a part of the core may intersect with at least one of two opening surfaces of the coil. A protruding portion of the core, which protrudes from the opening surface of the coil, decreases magnetic resistance to provide a higher inductance.

The core may be arranged between two opening surfaces of the coil. A higher Q factor can be obtained by enclosing the core in the coil.

The lamination portion may have a ratio of a thickness of the insulator relative to a thickness of the magnetic body, which is equal to or lower than about 0.2. Thus, magnetic saturation characteristics can be further improved. Further, the insulator may contain at least one type selected from a group consisting of epoxy resin, polyimide resin and polyimide amide resin. The insulator can therefore be formed to be thin, so that a ratio of the magnetic body relative to a volume of the overall core increases and magnetic saturation can be more effectively suppressed. Further, since the magnetic resistance of the core decreases, the inductance is further improved.

The magnetic body of the core may be made from a soft magnetic material selected from a group consisting of iron, silicon steel, permalloy, sendust, permendur, soft ferrite, an amorphous magnetic alloy, a nanocrystalline magnetic alloy, and an alloy thereof. By constructing the core using the soft magnetic material, a higher inductance can be easily achieved.

The sealing body may be a pressure molded body of a sealing material containing magnetic powder and resin. This makes it possible to achieve a higher inductance and higher magnetic saturation characteristics.

Hereinafter, embodiments of the disclosure will be described based on the drawings. However, the following embodiments describe examples of inductors for embodying the technical idea of the disclosure, and the disclosure is not limited to the following inductors. In addition, members described in the scope of the disclosure are not limited to the members in the embodiments. In particular, dimensions, materials, shapes, relative arrangements, and the like of constituting members described in the embodiments are not intended to limit the scope of the disclosure to only the range unless otherwise specified and are merely examples for explanation. In addition, sizes, positional relationships, and the like of the members illustrated in the drawings may be exaggerated for clarity of explanation. In the following description, the same reference terms and reference numerals denote the same or equivalent members, and detailed description thereof will be omitted as appropriate. Further, respective elements constituting the disclosure may be implemented such that a plurality of elements are formed by the same member and the member serves as the plurality of elements or conversely, a function of one member is shared by a plurality of members. Also, contents described in some embodiments can be utilized in other embodiments.

### First Embodiment

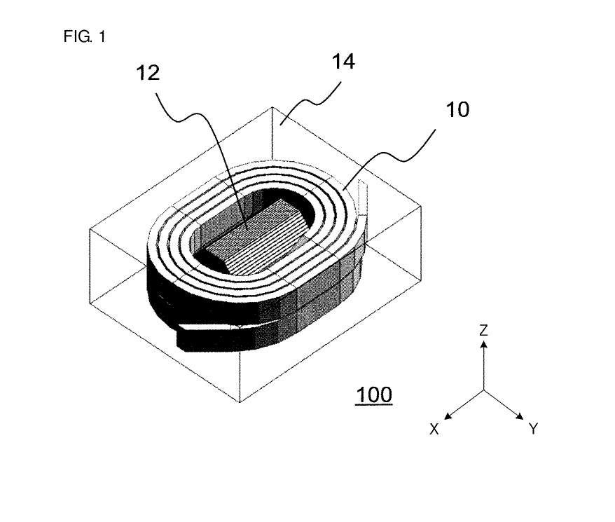

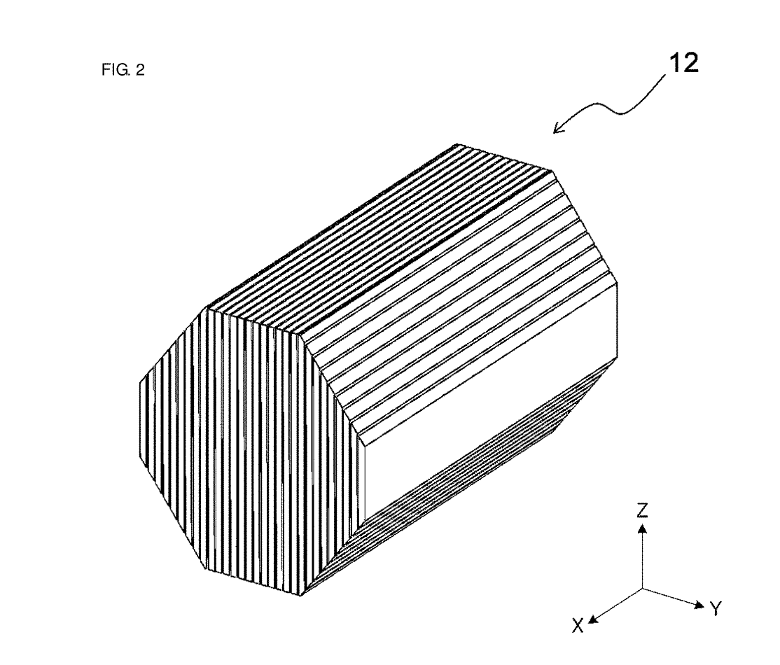

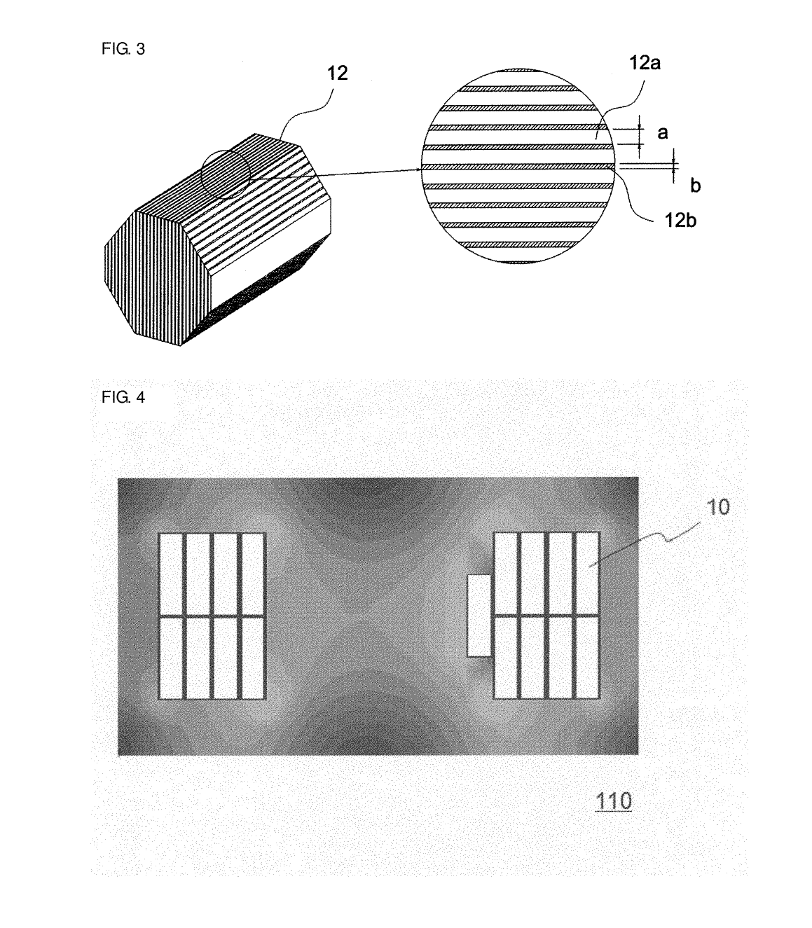

An inductor in a first embodiment will be described with reference to FIGS. 1 to 3. FIG. 1 is a transparent perspective view of the inductor in the first embodiment. FIG. 2 is a perspective view of a core that is used for the inductor in the first embodiment. FIG. 3 is an enlarged view of an upper surface (one of surfaces parallel to the lamination direction, which is not surrounded by a coil) of the core that is used for the inductor according to the first embodiment of the disclosure.

As illustrated in FIG. 1, an inductor 100 in the first embodiment includes a coil 10, a core 12 disposed in an inner side portion of the coil 10, and an sealing body 14 that seals the core 12 and the coil 10. The sealing body 14 is formed by applying pressure to a sealing material obtained by kneading magnetic powder and resin. From side surfaces of the sealing body 14, which are surfaces parallel to the winding axis direction of the coil, ends of the coil 10 are extracted respectively and are electrically connected to external terminals (not illustrated). The external terminals can be formed by, for example, applying resin containing silver, and then solidifying it. Further, the external terminals may be subjected to nickel plating, tin plating, or the like. For example, an amorphous alloy, a nanocrystal, or the like containing iron can be used as the magnetic powder constituting the sealing material.

The coil 10 is formed by winding an insulation coated conductor (hereinafter, referred to as a rectangular wire) having a substantially rectangular cross section such that ends of the conductor at the winding start and end sides are extracted from an outer periphery of the coil. In FIG. 1, an inner space of the coil 10 has a substantially elliptical columnar shape or a substantially oval columnar shape.

As illustrated in FIG. 2, the core 12 has a lamination portion in which magnetic bodies and insulators having substantially flat plate shapes are alternately laminated. The core 12 in FIG. 2 has a substantially rectangular upper surface which is one of surfaces (XY plane) parallel to the lamination direction (X direction) and the longitudinal direction (Y direction) of the core, a lower surface which faces the upper surface, two side surfaces which are substantially rectangular surfaces (YZ plane) orthogonal to the lamination direction, and two end surfaces which are substantially octagonal surfaces (XZ plane) parallel to the lamination direction (X direction) and orthogonal to the longitudinal direction (Y direction) of the core. In FIG. 1, the core 12 is arranged such that the lamination direction of the lamination portion and the winding axis direction (Z direction) of the coil 10 are orthogonal to each other.

In FIG. 2, the end surfaces of the core 12, which are parallel to both of the winding axis direction of the coil 10 and the lamination direction of the core 12, have the substantially convex octagonal shapes with two sides orthogonal to the winding axis direction of the coil 10 and two sides parallel to the winding axis direction of the coil 10. The core 12 has a substantially decahedral shape obtained by chamfering four ridge line portions parallel to the longitudinal direction of the core from a substantially rectangular parallelepiped core having substantially rectangular end surfaces along planes intersecting with both of the upper surface or the lower surface and the side surface of the core.

In one direction of the winding axis direction of the coil 10, for example, a direction from the lower surface of the core 12 toward the upper surface thereof, the core 12 has a region in which an area of a cross section orthogonal to the winding axis direction is larger than an area of a cross section of a near-side portion thereof, a region in which the areas are substantially unchanged, and a region in which the area of the cross section orthogonal to the winding axis direction is smaller than the area of the cross section of the near-side portion thereof. The region in which the area of the cross section orthogonal to the winding axis direction is larger than the area of the cross section of the near-side portion thereof corresponds to a region in which the area of the cross section orthogonal to the winding axis direction is smaller than the area of the cross section of the near-side portion thereof when viewed from the opposite direction in the winding axis direction. Therefore, the core 12 has a region in which the area of the cross section orthogonal to the winding axis direction is smaller than the area of the cross section of the near-side portion thereof in both of the directions in the winding axis direction of the coil 10.

In addition, the core 12 has a cross section having a region in which a length of the core 12 in the winding axis direction of the coil 10 in a portion closer to the coil 10 is shorter than that in a portion farther from the coil in at least part of a cross section parallel to the winding axis direction of the coil. For example, in the end surfaces of the core 12, a length of the side surfaces as portions close to the coil 10 is shorter than a length (also referred to as a height of the core) between the upper surface and the lower surface.

As illustrated in FIG. 3, the core 12 includes the lamination portion in which substantially flat plate-shaped magnetic bodies 12a and substantially flat plate-shaped insulators 12b are alternately laminated. The magnetic permeability of the magnetic bodies 12a constituting the core 12 is higher than that of the sealing material constituting the sealing body 14. In FIG. 3, the magnetic bodies 12a and the insulators 12b are alternately arranged without gaps therebetween. The insulators 12b bond the magnetic bodies 12a together and electrically insulate the magnetic bodies 12a from each other. The magnetic bodies 12a and the insulators 12b constituting the core 12 have substantially rectangular lamination surfaces. In addition, in the core 12, for the two magnetic bodies 12a laminated adjacently to each other, an area of the lamination surface of the magnetic body 12a which is closer to the coil 10 is equal to or smaller than an area of the lamination surface of the magnetic body 12a which is farther from the coil 10. An area of the lamination surface of the laminated magnetic body which is the closest to the coil 10 is smaller than areas of the lamination surfaces of the other magnetic bodies.

In order for the core 12 to have a high saturation magnetic flux density, a ratio (b/a, hereinafter, also referred to as a “thickness ratio”) of a thickness b of the insulators 12b relative to a thickness a of the magnetic bodies 12a is, for example, equal to or lower than about 0.3, preferably equal to or lower than about 0.2. The thickness b of the insulators 12b is, for example, equal to or larger than about 1 μm and equal to or smaller than about 5 μm (i.e., from about 1 μm to about 5 μm), preferably equal to or larger than about 1 μm and equal to or smaller than about 3 μm (i.e., from about 1 μm to about 3 μm). Further, the thickness a of the magnetic bodies 12a is, for example, equal to or larger than about 10 μm and equal to or smaller than about 30 μm (i.e., from about 10 μm to about 30 μm), preferably equal to or larger than about 10 μm and equal to or smaller than about 20 μm (i.e., from about 10 μm to about 20 μm).

Here, an example of a method of determining the thickness ratio (b/a) will be described. The thickness ratio (b/a) is obtained by dividing an average value of the thicknesses b of the insulators 12b by an average value of the thicknesses a of the magnetic bodies 12a constituting the lamination portion. The average value of the thicknesses a is obtained by measuring maximum thicknesses of the magnetic bodies 12a of respective layers in a cross-sectional observation image of the core and averaging the measured values. The average value of the thicknesses b is obtained by measuring minimum thicknesses of the insulators 12b of respective layers in the cross-sectional observation image of the core and averaging the measured values.

The insulators 12b are made from a material containing, for example, at least one resin selected from a group consisting of epoxy resin, polyimide resin, and polyimide amide resin, and/or glass with silicon oxide and the like. The magnetic bodies 12a have relative permeability of, for example, equal to or higher than about 1000 and equal to or lower than about 100000 (i.e., from about 1000 to about 100000).

The core 12 is disposed in an inner side portion of the coil 10 such that the lamination surfaces of the core 12 are parallel to the winding axis of the coil 10. In other words, the core 12 is disposed such that the lamination direction of the lamination portion and the winding axis of the coil 10 are orthogonal to each other. In addition, in FIG. 1, the core 12 is formed such that the height of the core 12 and the height of the coil 10 in the winding direction of the coil 10 are substantially equal to each other, and the core 12 is accommodated in the inner space of the coil 10. In other words, the core 12 is arranged between two opening surfaces of the coil 10, i. e., between two coil end surfaces orthogonal to the winding axis direction of the coil 10.

In FIG. 1, the core is arranged such that the lamination surfaces (YZ plane) of the core 12 and the longitudinal direction (Y direction) of the substantially elliptical coil 10 are parallel to each other, but the core may be arranged such that the lamination surfaces of the core 12 and the short-side direction (X direction) of the substantially elliptical coil 10 are parallel to each other and the lamination surfaces of the core 12 and the longitudinal direction of the substantially elliptical coil 10 may intersect with each other at an arbitrary angle. In FIGS. 2 and 3, the core 12 is formed of one lamination portion, but a plurality of lamination portions may be laminated in the winding axis direction of the coil 10 to form the core 12. That is, the core 12 may be divided along planes orthogonal to the winding axis direction of the coil 10. When the core 12 is formed of the plurality of lamination portions, a gap portion having low permeability may be disposed between the two lamination portions. In addition, in FIG. 1, the coil 10 is formed by a so-called substantially α-winding shape (for example, see Japanese Unexamined Patent Application Publication No. 2009-239076), but may be formed by edgewise winding, plated conductor pattern, or the like.

The inductor having such a structure has the following advantages. A first advantage is that a high inductance can be obtained. Since the core is constituted by the lamination portion including the magnetic bodies with the high magnetic permeability, the high inductance can be obtained. In other words, in order to obtain a predetermined inductance, the number of turns of the coil can be reduced. This reduces DC resistance of the inductor.

A second advantage is that concentration of magnetic fluxes in the core is moderated. In an inductor having a core inside a coil, magnetic flux concentration tends to occur on an outer peripheral portion of the core, which is close to the coil. However, in the inductor having the core of the above-described shape, when viewed from the winding axis direction of the coil, the length of the magnetic bodies in an outer peripheral portion of the core is shorter than that in an inner side portion of the core, so that difference in magnetic resistance between the outer peripheral portion and the inner side portion of the core including the sealing material becomes small. As a result, concentration of the magnetic fluxes on the outer peripheral portion of the core is moderated, and the magnetic fluxes are easily distributed throughout the core. Therefore, eddy current loss and hysteresis loss in the core and the sealing material can be reduced and an equivalent Q factor to that of an inductor with no core can be obtained even though the high inductance.

A third advantage is that loss of the inductor due to eddy current is small. In general, loss Pe caused by eddy current is proportional to the square of an area of a conductor plane orthogonal to the direction of the magnetic fluxes generated from the coil. In the inductor in the first embodiment, a conductor plane orthogonal to the magnetic fluxes generated from the coil is a plane (a cross section orthogonal to the winding axis direction) formed by the thickness of the thin soft magnetic body and the longitudinal direction of the core. Since the soft magnetic body is sufficiently thin, an area of the plane where the eddy current is generated is also small. It is possible to suppress the eddy current loss Pe of the inductor by suppressing a value of the eddy current which is generated by the magnetic fluxes of the coil.

A fourth advantage is that magnetic saturation is less likely to occur. A material having a high saturation magnetic flux density Bs is used for the magnetic bodies 12a. As for the thicknesses of the magnetic bodies 12a and the insulators 12b, the ratio of the magnetic bodies 12a is increased to provide a core having high magnetic saturation characteristics. For example, if the thickness b=1 of the insulators 12b is set for the thickness a=19 of the magnetic bodies 12a, a core of which magnetic saturation characteristics is substantially 95% of the saturation magnetic flux density Bs of the material constituting the magnetic bodies is obtained. An inductor having the above-described core establishes series connection between the magnetic bodies 12a and the sealing body 14 where the magnetic bodies 12a have high magnetic permeability, low magnetic resistance, and a high saturation magnetic flux density and the sealing body 14 has low magnetic permeability and high magnetic resistance in terms of a magnetic circuit. Thus, the inductor has a structure that is hardly magnetically saturated with the high saturation magnetic flux density of the magnetic bodies 12a and the high magnetic resistance characteristics of the sealing body 14. By increasing the ratio of the magnetic bodies relative to the insulators and increasing the saturation magnetic flux density Bs of the core 12 itself, it becomes possible to obtain an inductor which is less likely to be magnetically saturated.

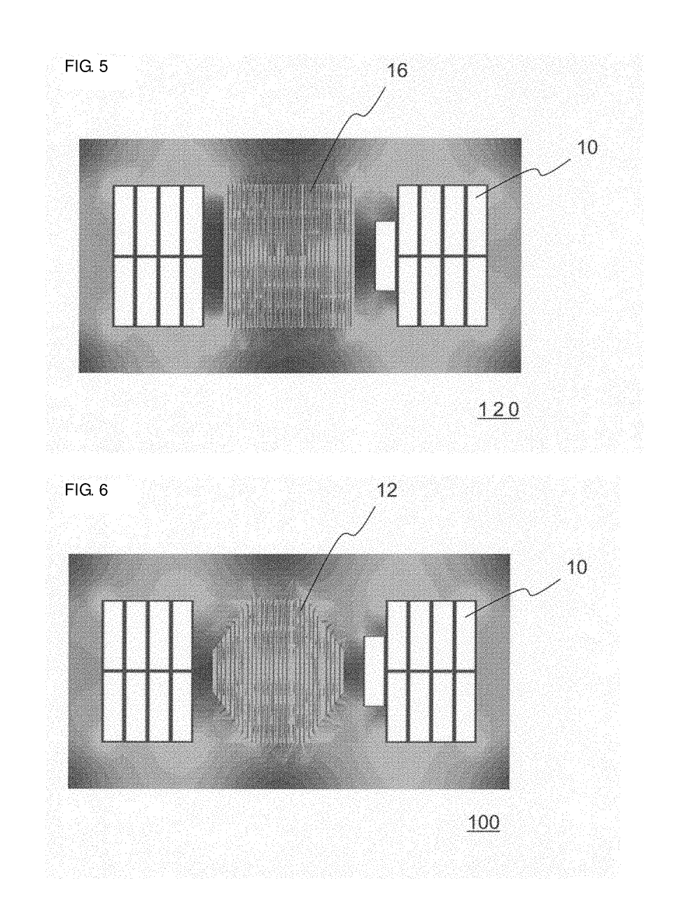

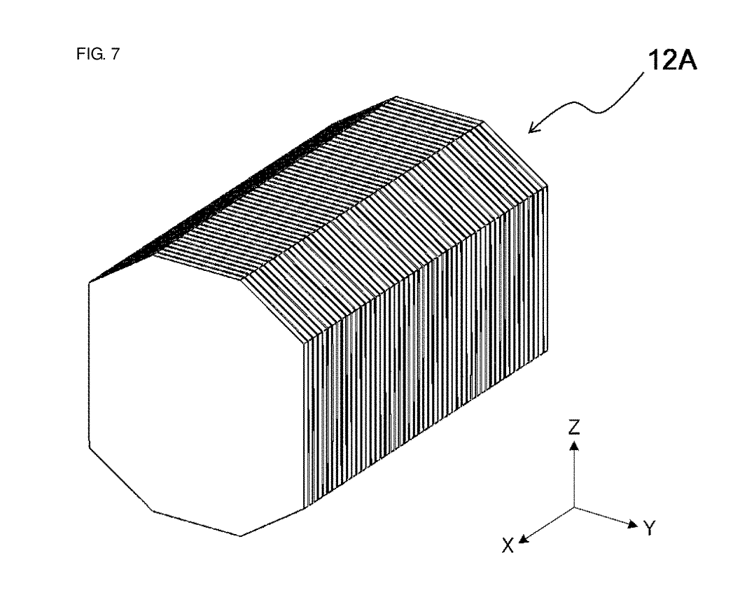

FIGS. 4 to 6 illustrate results of visualization of magnetic simulation of magnetic flux density distribution in an inductor. As electric characteristics of the inductor obtained by the simulation, an inductance (L), a resistance value (Rs), and a Q factor are shown in Table 1. The simulation was carried out by harmonic magnetic field analysis at a frequency of about 1 MHz using the finite element analysis software Femtet (developed by Murata Software Co., Ltd.). FIGS. 4 to 6 illustrate a magnetic flux density in a cross section parallel to both of the winding axis direction of the coil 10 and the lamination direction of the core 12, and indicates that the magnetic fluxes are concentrated at a higher degree as the color is whiter. FIG. 4 is a cross-sectional view illustrating magnetic flux density distribution of an inductor 110 having no core therein. In FIG. 4, the magnetic flux density in the vicinity of the coil 10 is high and the magnetic flux density decreases toward the center of the coil. FIG. 5 is a cross-sectional view illustrating magnetic flux density distribution of an inductor 120 in which a substantially columnar core 16 having a substantially rectangular cross section parallel to the winding axis direction of the coil 10 and the lamination direction of the core 16 is disposed inside the coil 10. In FIG. 5, the magnetic flux density is increased in a region of the substantially columnar core 16, which is close to the coil 10, i. e., an outer peripheral portion thereof, and magnetic fluxes are concentrated in an outer peripheral portion of the substantially columnar core. FIG. 6 is a cross-sectional view illustrating magnetic flux density distribution of the inductor 100 in which the substantially columnar chamfered core 12 having the substantially octagonal cross section parallel to the winding axis direction of the coil 10 and the lamination direction of the core 16 is disposed inside the coil 10. In FIG. 6, concentration of the magnetic fluxes is moderated in the region of the core 12, which is close to the coil 10, i. e., in the outer peripheral portion of the core 12, which is close to the coil, and the magnetic fluxes spread over the whole core 12.

TABLE 1

| INDUCTOR | L (μH). | Rs (Ω). | Q |
|---|---|---|---|
| 110 | 0.751 | 0.146 | 32.23 |
| 120 | 1.014 | 0.205 | 31.03 |
| 100 | 0.942 | 0.186 | 31.89 |

In the inductor 110 having no core therein, the inductance L is low but the Q factor is high. In the inductor 120 having the substantially columnar core 16 which is not chamfered, a high inductance L is obtained but the resistance Rs is large and the Q factor is low. In the inductor 100 including the substantially columnar chamfered core 12 having the substantially octagonal cross section, the inductance L is improved as compared with that of the inductor 110 and the inductance L equivalent to that of the inductor 120 is obtained. In addition, in the inductor 100, the resistance Rs decreases as compared with that of the inductor 120 and the Q factor equivalent to that of the inductor 110 can be achieved. In other words, in the inductor 100, both of the high inductance and the high Q factor can be achieved.

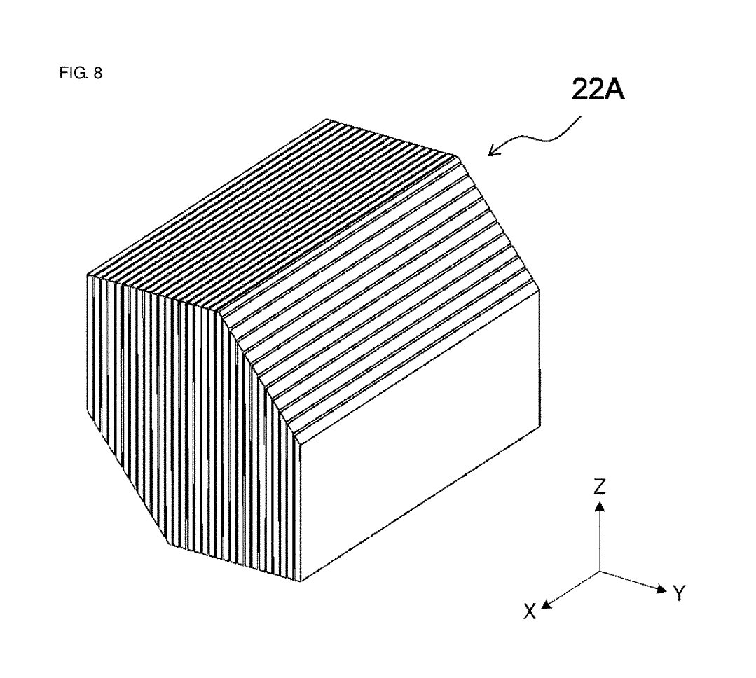

FIG. 7 is a perspective view of a core 12A having a shape similar to that of the core 12 included in the inductor 100. The core 12A in FIG. 7 has a shape similar to that of the core 12 in that it has a substantially columnar shape having a substantially octagonal cross section, but is different from the core 12 in the lamination direction of the magnetic bodies and the insulators. In an inductor including the core 12A, the longitudinal direction of the substantially oval coil 10 is identical with the lamination direction of the magnetic bodies and the insulators. The core 12A has a region in which an area of a cross section orthogonal to the winding axis direction is smaller than an area of a cross section of a near-side portion thereof in at least one direction of a winding axis of the coil. As a result, in the inductor including the core 12A, concentration of magnetic fluxes is moderated similarly to the inductor 100 including the core 12.

### Second Embodiment

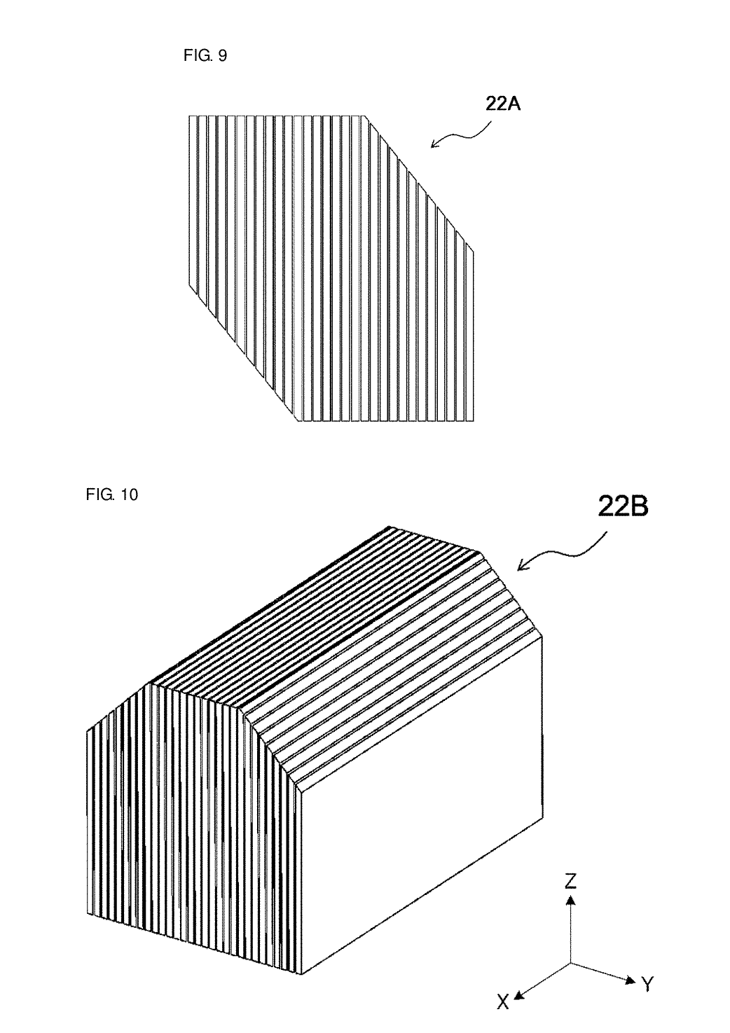

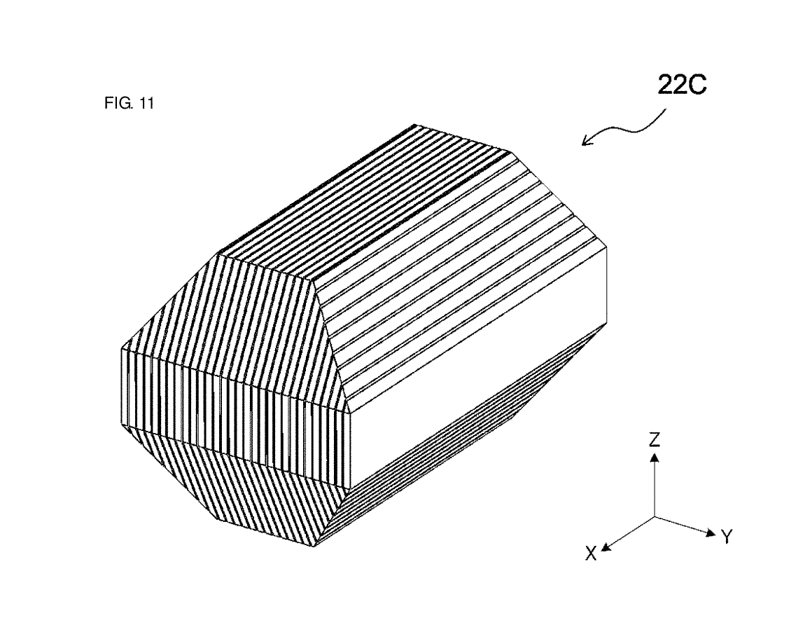

FIGS. 8 and 10 to 15 are perspective views of cores 22A to 22G each of which is used for an inductor in a second embodiment, and FIG. 9 is a cross-sectional view of a surface of the core 22A, which is parallel to the winding axis direction of a coil and the lamination direction of the core. Although the core 12 in the inductor 100 in the first embodiment is the substantially columnar core having the substantially octagonal cross section orthogonal to the longitudinal direction, a core having a shape obtained by chamfering at least some ridge lines of a substantially columnar core is used in the inductor in the second embodiment. As illustrated in FIGS. 8 and 10 to 15, each of the cores 22A to 22G has a region in which an area of a cross section orthogonal to the winding axis direction is smaller than an area of a cross section of a near-side portion thereof in at least one direction of a winding axis of the coil. Thus, in the inductor including any of the cores 22A and 22G, concentration of magnetic fluxes on an outer peripheral portion of the core is moderated, and a high inductance and a high Q factor can be achieved.

The core 22A in FIG. 8 has a substantially octahedral shape that among four ridge line portions, in the longitudinal direction, of a substantially quadrangular columnar core having a substantially rectangular cross section parallel to the winding axis direction of the coil and the lamination direction of the core, two ridge line portions diagonally positioned in the cross section are chamfered along planes intersecting with the upper surface or the lower surface and the side surface thereof. A cross section of the core 22A, which is illustrated in FIG. 9, has a substantially hexagonal shape with two sides parallel to the lamination direction of the core 22A and two sides parallel to the winding axis of the coil. In addition, in the cross section of the core 22A, a length of an outer side region close to the coil in the winding axis direction of the coil is shorter than a height of the core in the winding axis direction of the coil, i. e., a length between the upper and lower surfaces. Since the core 22A has fewer ridge line portions which are chamfered than those of the core 12, the manufacturing process of the core can be simplified.

The core 22B in FIG. 10 has a substantially octahedral shape that among four ridge line portions, in the longitudinal direction, of a substantially quadrangular columnar core having a substantially rectangular cross section parallel to the winding axis direction of the coil and the lamination direction of the core, two ridge line portions at the side of one side of two sides parallel to the lamination direction of the core in the cross section are chamfered along planes intersecting with the upper surface or the lower surface and the side surface thereof. A cross section of the core 22B along a plane (XZ plane) parallel to the winding axis direction of the coil and the lamination direction of the core has a substantially hexagonal shape with two sides parallel to the lamination direction of the core 22B and two sides parallel to the winding axis of the coil. In addition, in the cross section of the core 22B, a length of an outer side region close to the coil in the winding axis direction of the coil is shorter than a height of the core in the winding axis direction of the coil, i. e., a length between the upper and lower surfaces thereof. Since the core 22B has fewer ridge line portions which are chamfered than those of the core 12, the manufacturing process of the core can be simplified.

In the core 22B illustrated in FIG. 10, a length of the two sides parallel to the winding axis direction of the coil in the cross section parallel to the winding axis direction of the coil and the lamination direction of the core is longer than a length of portions removed by chamfering. However, the length of the portions removed by chamfering may be longer. In addition, although the cross section in FIG. 10 has two sides parallel to the lamination direction, the ridge line portions may be chamfered such that the lengths of the sides parallel to the lamination direction (X direction) are 0. In other words, the cross section may have a substantially pentagonal shape. Further, the two ridge line portions may be chamfered along planes intersecting with the upper and lower surfaces such that the length of the two sides parallel to the winding axis direction (Z direction) of the coil is 0. In other words, the cross section may have a substantially trapezoidal shape.

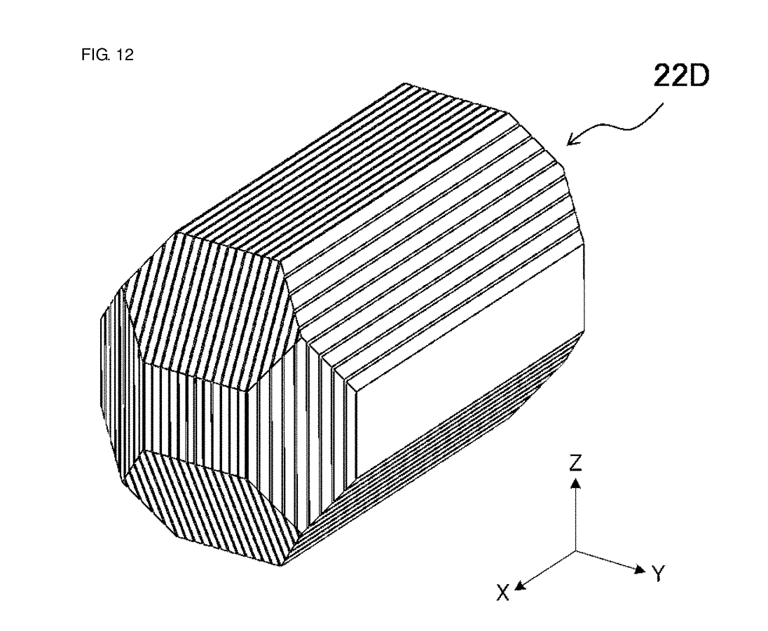

The core 22C in FIG. 11 has a substantially tetradecahedral shape that four ridge line portions including sides parallel to the lamination direction (X direction) of the core as ridge lines are chamfered along planes intersecting with the upper surface or the lower surface and the end surface on the end surfaces orthogonal to the longitudinal direction of the core 12. Therefore, in the core 22C, the shape of the cross section parallel to both the winding axis direction of the coil and the lamination direction (X direction) of the core changes into a substantially rectangular shape, a substantially octagonal shape, and a substantially rectangular shape along the longitudinal direction (Y direction) of the core, for example. In FIG. 11, a length of sides of outermost layer surfaces of the core 22C in the lamination direction, which are parallel to the winding axis direction of the coil, and a length of sides of the end surfaces of the core 22C in the longitudinal direction, which are parallel to the winding axis direction of the coil, are substantially equal to each other, but may be different from each other. In addition, the length of the sides of the end surfaces of the core 22C in the longitudinal direction, which are parallel to the winding axis direction of the coil, may be 0. That is, it is not necessary for the core 22C to have the end surfaces. In the core 22C, a length, in the winding axis direction of the coil, of a region close to the coil in the longitudinal direction is shorter than a height of the core in the winding axis direction of the coil. Thus, concentration of magnetic fluxes on an outer peripheral portion of the core 22C is further moderated.

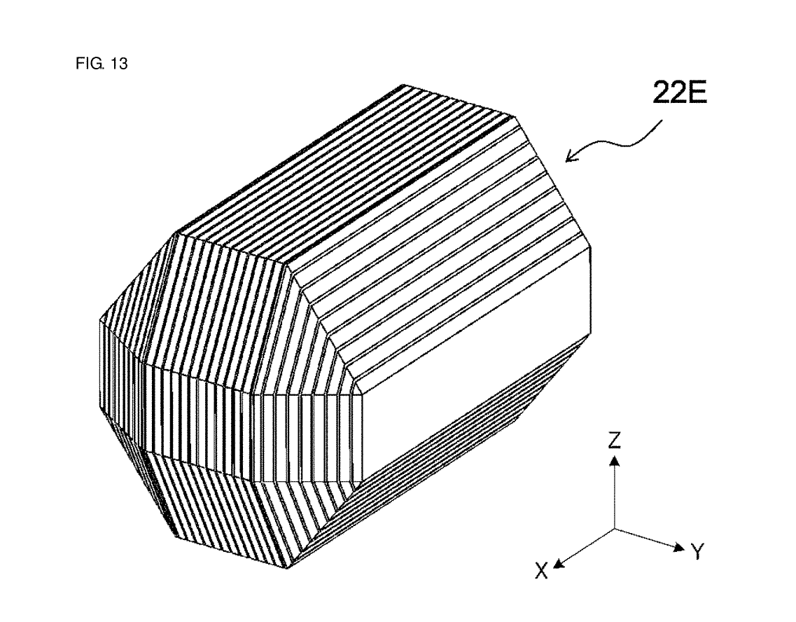

The core 22D in FIG. 12 has a substantially octadecahedral shape that four ridge line portions including sides parallel to the winding axis direction (Z direction) of the coil as ridge lines are chamfered along planes intersecting with the side surface and the end surface on the end surfaces orthogonal to the longitudinal direction of the core 22C. In the core 22D, side surface corners of the core 22C are further chamfered, so that a larger-sized core can be disposed in an inner side portion of the coil. This further increases an inductance. In the core 22D, a length, in the winding axis direction of the coil, of a region close to the coil in the longitudinal direction is shorter than a height of the core in the winding axis direction of the coil. Thus, concentration of magnetic fluxes on an outer peripheral portion of the core 22D is further moderated.

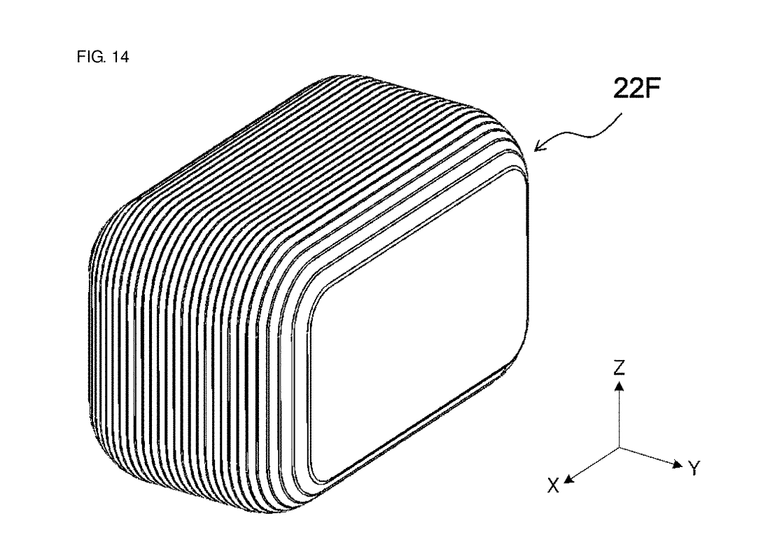

The core 22E in FIG. 13 has a substantially icosihexahedral shape that eight corner portions of substantially triangular pyramid shapes each having a bottom surface of a substantially minimum triangular shape connecting a vertex of a substantially rectangle on an upper surface or a lower surface of the core 22D, a vertex of a substantially rectangle on a side surface of the core 22D in the longitudinal direction, and a vertex of a substantially rectangle on an end surface of the core 22D, which is orthogonal to the longitudinal direction, are chamfered along planes. In other words, the core 22E has the substantially icosihexahedral shape that the eight corner portions of the substantially triangular pyramid shapes each having three ridge lines formed by two surfaces which respectively share sides with two adjacent sides of the upper surface or the lower surface of the core 22D, and a surface which shares two sides with the side surface of the core 22D in the longitudinal direction and the end surface thereof which is orthogonal to the longitudinal direction are chamfered along the planes. In the core 22E, a length of an outer peripheral portion in the winding axis direction of the coil is shorter than a height of the core in the winding axis direction of the coil. Thus, concentration of magnetic fluxes on the outer peripheral portion of the core 22E is moderated.

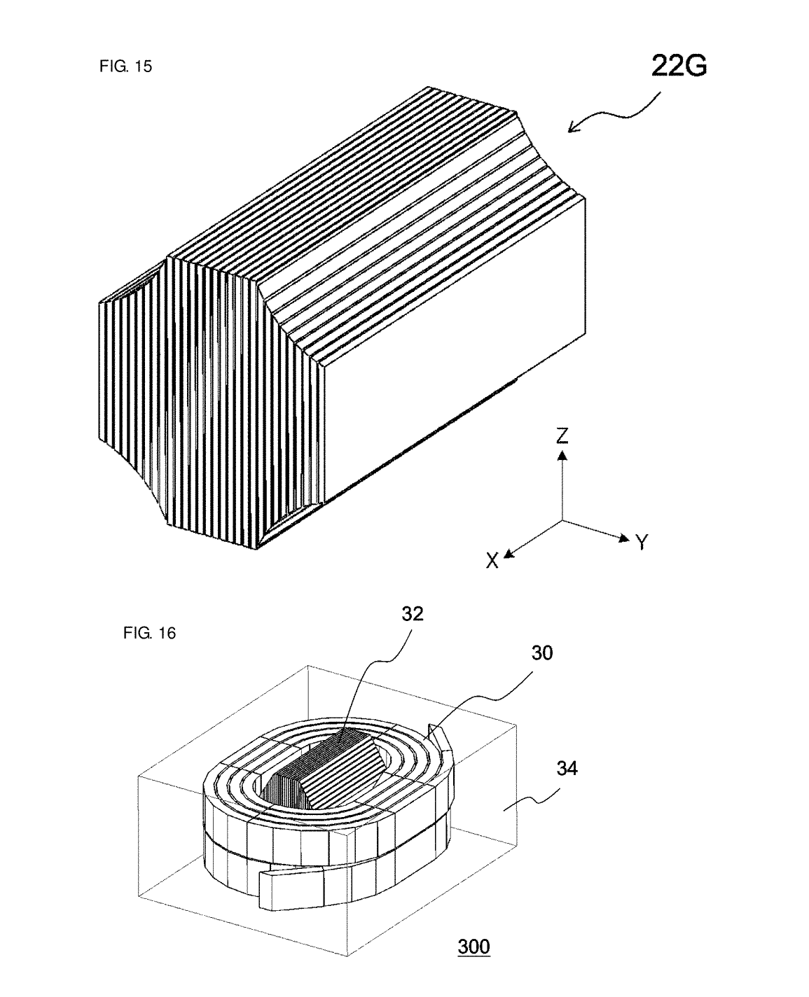

In each of the above-described cores 12 and 22A to 22E formed by performing chamfering on the substantially rectangular parallelepiped columnar core, the ridge line portions are chamfered along the planes but the shapes of the chamfered portions are not limited to the planes. In the core 22F in FIG. 14, all of twelve ridge line portions are chamfered into substantially arc-like forms from a substantially rectangular parallelepiped columnar core having a substantially rectangular cross section parallel to both of the winding axis direction of a coil and the lamination direction of the core. For example, the core 22F can be easily manufactured by chamfering the ridge line portions of the substantially rectangular parallelepiped columnar core into the substantially arc-like forms by a method such as barrel polishing. In this way, the core may have a shape other than the substantially polygonal shape in which cross sections or end surfaces have definite vertices and straight sides. In addition, in the core 22G in FIG. 15, four ridge line portions of a substantially rectangular parallelepiped columnar core in the longitudinal direction are chamfered into substantially inverted arc-like forms. In each of the cores 22F and 22G, a length of an outer peripheral portion in the winding axis direction of the coil is shorter than a height of the core in the winding axis direction of the coil. Thus, concentration of magnetic fluxes on the outer peripheral portion of each of the cores 22F and 22G is moderated.

### Third Embodiment

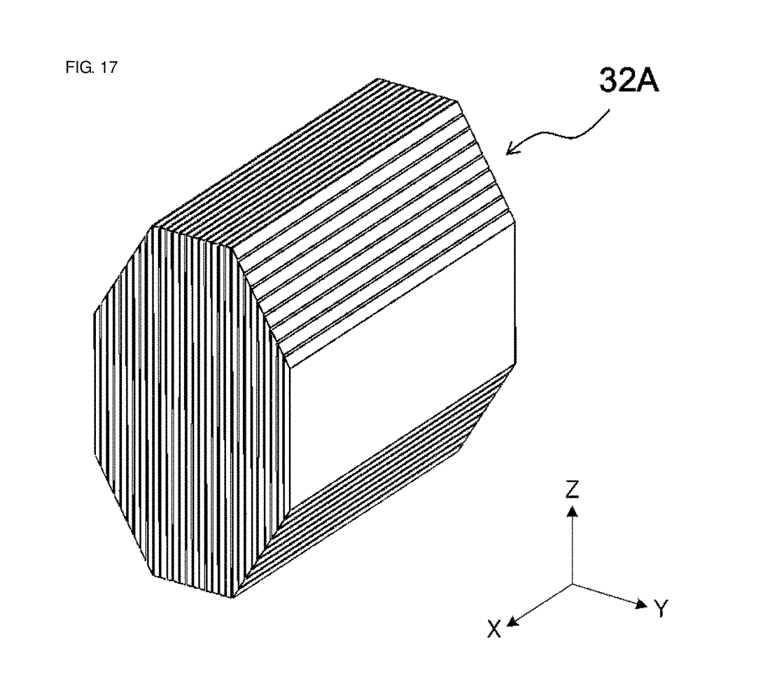

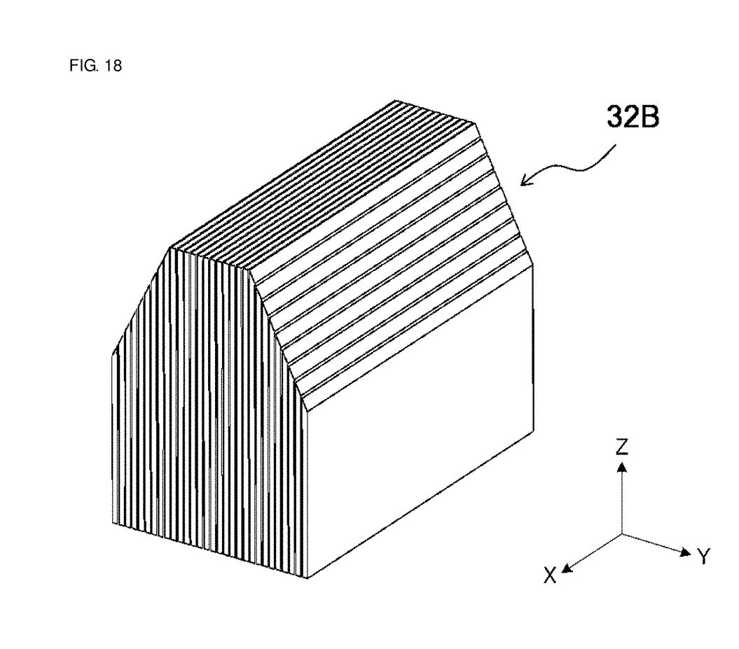

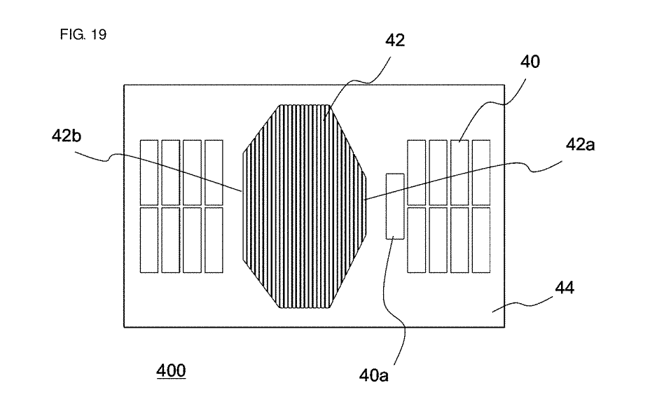

An inductor in a third embodiment will be described with reference to FIGS. 16 to 18. FIG. 16 is a transparent perspective view of an inductor 300 in the third embodiment. FIG. 17 is a perspective view illustrating an example of a core that is used for the inductor 300 in the third embodiment. FIG. 18 is a perspective view illustrating another example of a core that is used for the inductor 300 in the third embodiment.

In the inductor 100 in the first embodiment, the core is disposed between the two opening surfaces of the coil. However, in the inductor 300 illustrated in FIG. 16, a height of a core 32 in the winding axis direction of a coil 30 is higher than a height of the coil 30, and a part of the core 32 intersects with at least one of two opening surfaces of the coil 30. In a region near a central portion of the coil 30, the length of the core 32 in the winding axis direction of the coil 30 is long, so that a magnetic flux density in regions close to a sealing material at the upper and lower sides of the central portion of the coil 30 can be improved. As a result, it is possible to further disperse magnetic fluxes to overall the inductor and to further improve a Q factor.

The inductor 300 in the third embodiment includes the coil 30, the core 32 disposed in an inner side portion of the coil 30, and an sealing body 34 that seals the core 32 and the coil 30. In FIG. 16, a part of the core 32 protrudes from at least one of the opening surfaces of the coil 30. In the inductor 300, in one direction in the winding axis direction of the coil 30, for example, in a direction from the lower surface of the core 32 toward the upper surface thereof, a region, in which an area of a cross section orthogonal to the winding axis direction of the core 32 is smaller than an area of a cross section of a near-side portion thereof, protrudes from the opening surface of the coil 30. However, a region, in which the area of the cross section orthogonal to the winding axis direction of the core 32 is substantially unchanged from the area of the cross section of the near-side portion thereof, may also protrude from the opening surface of the coil 30. As for the shape of the core 32, it is sufficient that the height of the core 32 in the winding axis direction of the coil 30 is higher than that of the coil 30, and it is possible to appropriately select the shape from the above-described core shapes.

FIG. 17 is a perspective view of a core 32A which is an example of the core 32 included in the inductor 300. In the core 32A, a height of the core 32A, which is a distance between the upper surface and the lower surface, is higher than a height of the coil 30. In addition, the core 32A has a region in which an area of a cross section orthogonal to the winding axis direction is larger than an area of a cross section of a near-side portion thereof in the direction from the lower surface toward the upper surface, a region in which the areas are substantially unchanged, and a region in which the area of the cross section orthogonal to the winding axis direction is smaller than the area of the cross section of the near-side portion thereof. In addition, a cross section of the core 32A, which is parallel to the winding axis direction of the coil 30 and the lamination direction of the lamination portion, has a substantially convex octagonal shape with two sides orthogonal to the winding axis direction of the coil 30 and two sides parallel to the winding axis direction of the coil 30.

FIG. 18 is a perspective view of a core 32B which is an example of the core 32 included in the inductor 300. In the core 32B, a height of the core 32B, which is a distance between the upper surface and the lower surface, is higher than a height of the coil 30. In addition, the core 32B has a region in which an area of a cross section orthogonal to the winding axis direction is substantially unchanged from an area of a cross section of a near-side portion thereof in the direction from the lower surface toward the upper surface and a region in which the area of the cross section orthogonal to the winding axis direction is smaller than the area of the cross section of the near-side portion thereof. In addition, a cross section of the core 32B along a surface (XZ plane) parallel to the winding axis direction of the coil 30 and the lamination direction of the lamination portion has a substantially hexagonal shape with two sides orthogonal to the winding axis direction of the coil 30 and two sides parallel to the winding axis direction of the coil 30.

### Fourth Embodiment

An inductor in a fourth embodiment will be described with reference to FIG. 19. FIG. 19 is a cross-sectional view of an inductor 400 in the fourth embodiment along a surface parallel to a winding axis direction of a coil and a lamination direction of a core. The inductor 400 includes a coil 40, a core 42 disposed in an inner side portion of the coil 40, and an sealing body 44 that seals the core 42 and the coil 40. In the inductor 400, like the inductor 300 in the third embodiment, a part of the core 42 protrudes from an opening surface of the coil. In addition, in the inductor 400, a length of one side surface 42a of the core 42 is different from a length of the other side surface 42b thereof in the winding axis direction of the coil 40, and the core 42 has a substantially asymmetrical octagonal cross-sectional shape. In the coil 40, a rectangular wire is started to be wound from a winding start portion 40a and respective ends of the rectangular wire are extracted to opposing surfaces from an outermost periphery of the coil 40. Therefore, difference of about 0.5 turns of the coil is generated between the right and left sides in the extraction direction of the ends, and the magnetic fluxes do not become symmetrical with respect to the center of the coil 40. In the inductor 400, the core 42 has a shape that a length of the side surface 42a of the core with the larger number of turns in the winding axis direction of the coil is shorter than a length of the side surface 42b of the core with the smaller number of turns. As a result, it is possible to more effectively disperse magnetic fluxes at the side with the larger number of turns and to further improve a Q factor.

Although the embodiments have been described hereinbefore, the disclosure is not limited to the embodiments.

The core shape may be a shape that entirely fills the inner side portion of the coil or a shape that fills the inner side portion of the coil with a gap partially. The shape of the core is not limited to the shapes exemplified above as long as it has a region in which an area of a cross section orthogonal to the winding axis direction is smaller than an area of a cross section of a near-side portion thereof in at least one direction of the winding axis direction of the coil. For example, the core may have any of a substantially pyramid shape having a substantially polygonal bottom surface, such as a substantially triangular pyramid or a substantially quadrangular pyramid, a substantially conical shape or a substantially elliptical cone shape having a substantially circular, elliptical, or oval bottom surface, a substantially spherical shape, a substantially spheroid shape, a shape obtained by bonding bottom surfaces of two substantially cones or pyramids, and the like. In addition, the height of the core in the winding axis direction of the coil may be the same as or different from the height of the coil. Depending on the characteristics desired for the inductor, the height of the core may be higher or lower than the height of the coil.

The substantially flat plate-shaped magnetic bodies constituting the core are made from a soft magnetic material selected from a group consisting of, for example, iron, silicon steel, permalloy, sendust, permendur, soft ferrite, an amorphous magnetic alloy, a nanocrystalline magnetic alloy, and an alloy thereof. As long as the magnetic bodies have high permeability, the magnetic bodies are not limited to be made from the soft magnetic material and may be made from any of other material.

The shape of the insulators forming the core is not limited to the substantially flat plate shape and any shape can be used as long as insulation between the magnetic bodies can be achieved.

The conductor constituting the coil is not limited to the rectangular wire and may be a round wire having a substantially circular cross section or may have another shape. Further, the shape of the coil is not limited to the substantially elliptical shape and may be a substantially circular shape or the like.

The material constituting the sealing body is, for example, the sealing material obtained by kneading the magnetic powder and the resin, and the magnetic powder may be metal magnetic powder, ferrite magnetic powder, or the like. Further, the sealing body is not limited to the sealing material obtained by kneading the magnetic powder and the resin and may be made from another material such as ferrite.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An inductor comprising:
a core;
a coil having a conductor wound around the core; and
a sealing body accommodating the core and the coil,
wherein
the core includes a lamination portion in which a magnetic body and an insulator are alternately laminated, and the lamination portion is arranged such that a lamination direction of the lamination portion is orthogonal to a winding axis of the coil,
the magnetic body of the core has higher magnetic permeability than the sealing body, and
the core has a region in which an area of a cross section orthogonal to a winding axis direction is smaller than an area of a cross section of a near-side portion in at least one direction of the winding axis of the coil.

2. The inductor according to claim 1, wherein
the core has a cross section of a substantially convex polygonal shape with two parallel sides orthogonal to the winding axis direction of the coil and equal to or more than six vertices in a cross section parallel to the winding axis direction of the coil and parallel to or orthogonal to the lamination direction of the lamination portion.

3. The inductor according to claim 1, wherein
the core has a cross section of a substantially convex octagonal shape with two parallel sides orthogonal to the winding axis direction of the coil in a cross section parallel or orthogonal to the winding axis direction of the coil and the lamination direction of the lamination portion.

4. The inductor according to claim 1, wherein
a height of the core is higher than a height of the coil in the winding axis direction of the coil, and
a part of the core intersects with at least one of two opening surfaces of the coil.

5. The inductor according to any one of claim 1, wherein
the core is arranged between two opening surfaces of the coil.

6. The inductor according to claim 1, wherein
the lamination portion has a ratio of a thickness of the insulator relative to a thickness of the magnetic body, which is equal to or lower than about 0.2.

7. The inductor according to claim 1, wherein
the insulator contains at least one type selected from a group consisting of epoxy resin, polyimide resin, and polyimide amide resin.

8. The inductor according to claim 1, wherein
the magnetic body of the core is made from a soft magnetic material selected from a group consisting of iron, silicon steel, permalloy, sendust, permendur, soft ferrite, an amorphous magnetic alloy, a nanocrystalline magnetic alloy, and an alloy of any of the soft magnetic materials.

9. The inductor according to claim 1, wherein
the sealing body is a pressure molded body of a sealing material containing magnetic powder and resin.

10. The inductor according to claim 2, wherein
a height of the core is higher than a height of the coil in the winding axis direction of the coil, and
a part of the core intersects with at least one of two opening surfaces of the coil.

11. The inductor according to claim 3, wherein
a height of the core is higher than a height of the coil in the winding axis direction of the coil, and
a part of the core intersects with at least one of two opening surfaces of the coil.

12. The inductor according to any one of claim 2, wherein
the core is arranged between two opening surfaces of the coil.

13. The inductor according to any one of claim 3, wherein
the core is arranged between two opening surfaces of the coil.

14. The inductor according to claim 2, wherein
the lamination portion has a ratio of a thickness of the insulator relative to a thickness of the magnetic body, which is equal to or lower than about 0.2.

15. The inductor according to claim 3, wherein
the lamination portion has a ratio of a thickness of the insulator relative to a thickness of the magnetic body, which is equal to or lower than about 0.2.

16. The inductor according to claim 2, wherein
the insulator contains at least one type selected from a group consisting of epoxy resin, polyimide resin, and polyimide amide resin.

17. The inductor according to claim 3, wherein
the insulator contains at least one type selected from a group consisting of epoxy resin, polyimide resin, and polyimide amide resin.

18. The inductor according to claim 2, wherein
the magnetic body of the core is made from a soft magnetic material selected from a group consisting of iron, silicon steel, permalloy, sendust, permendur, soft ferrite, an amorphous magnetic alloy, a nanocrystalline magnetic alloy, and an alloy of any of the soft magnetic materials.

19. The inductor according to claim 3, wherein
the magnetic body of the core is made from a soft magnetic material selected from a group consisting of iron, silicon steel, permalloy, sendust, permendur, soft ferrite, an amorphous magnetic alloy, a nanocrystalline magnetic alloy, and an alloy of any of the soft magnetic materials.

20. The inductor according to claim 2, wherein
the sealing body is a pressure molded body of a sealing material containing magnetic powder and resin.
